(19) United States
(12) Patent Application Publication
(10) Pub. No.: US 2009/0111292 A1
(43) Pub. Date: Apr. 30, 2009

(54) Surface Mount Technology Pad Layout for Docking Connector Systems

(76) Inventors: William Louis Brodsky, Binghamton, NY (US); Mark Kenneth Hoffmeyer, Rochester, MN (US)

Correspondence Address: WARD AND SMITH, P.A., 1001 COLLEGE COURT, P.O. BOX 867, NEW BERN, NC, 28563-0867, US

(21) Appl. No.: 11/931,220

(22) Filed: Oct. 31, 2007

(51) Int. Cl. H01R 12/06

(52) U.S. Cl. 439/69

(57) ABSTRACT

A pad array for a surface mount technology board includes a front row ground pad as a single pad, followed by a signal pad. The ground pads internal to the array may be arranged as pairs of pads interconnected to each other, with sandwiching signal pads on the internal portion of the array. To minimize stress on connector wafers of large scale connectors, external rows of ground pads may be enlarged by a predetermined amount in a Y-direction to minimize potential formation of stress risers, while ensuring that electrical spacing requirements to adjacent signal leads may be preserved for optimal signal integrity.

### FIELD OF THE INVENTION

This invention relates generally to computer hardware connections, and more particularly, to structures used in docking large scale surface mount technology array connectors to circuit boards.

### BACKGROUND OF THE INVENTION

Mainframe server computers, such as those available commercially from International Business Machines Corporation, use large scale surface mount technology (SMT) array connectors for fast and reliable bus communications between processor node cards. Right angle receptacle connectors generally include an array of wafers with molded spring beam contacts mounted onto the node cards. Node to node communication is accomplished by docking the receptacle connectors that are SMT mounted to backplane or midplane cards located within the central electronics complexes of the computers, and are made up of an array of wafers having insert molded contact blades.

Node cards can be relatively heavy and require complex mechanical docking systems for support. Cards typically also benefit from mechanical guidance structures and book packaging to ensure successful and reliable mating of the high speed connectors. The cumbersome nature of the system planars and node cards can translate into structural deflections of support hardware and cards. Eccentricity of mating connector faces may additionally occur during docking. These conditions in combination can drive tensile and shear stresses on individual connector wafers and their respective solder joints during the docking process.

Mechanical reinforcements are conventionally used to dock the node hardware and to minimize the stress transfer to connector wafers. Even with optimized hardware for docking, however, concerns persist regarding tensile and shear stresses arising on front row solder joints of right-angle receptacle connectors. More specifically, such solder joints nearest to the node board edge are particularly vulnerable to such stresses, which often result in solder joint cracks during docking.

Accordingly, there exists a need for an improved SMT pad configuration on circuit boards to address the stresses associated with docking and physical connectivity.

### SUMMARY OF THE INVENTION

In accordance with one aspect of the invention, there is provided a surface mount technology pad layout for a circuit board. The circuit board includes a pad array for having an electrical connector affixed to the pad array. The pad array may comprises a plurality of electrical connection pads arranged in rows and columns. Each column may include a front and last row connection pad, with one or more internal pads positioned therebetween. The plurality of electrical connection pads may include, among other configurations, alternating pairs of ground pads and signal connection pads. In accordance with aspects of the invention, the front row ground pad may be configured as having a width that is greater than the respective widths of the internal connection pad(s) of the array. More particularly, the width may be at least 25 percent larger than the width of at least one of the other connection pads, and the width may be most preferably at least 50 percent larger than the width of the other of the one or more connection pads.

In a further embodiment, since such stresses can also arise on the outermost back or last row pad, the last row connection pad may also be enlarged in the same manner.

In accordance with an alternative embodiment, the first row of the ground pad for each column may be configured as a pair of electrically interconnected pads. In this case, wafers in a connector may be modified to include an additional lead, which may be soldered onto the connection pads of the circuit board. As with other embodiments consistent with the invention, the front pad of the pair of pads may be made larger, as described above.

Similar to the first embodiment, stresses on the outermost back, or last row pad, may also arise, and the last row pad may be constructed like the first row, i.e., with the wider of the pair arranged last in the row of connection pads.

In a further embodiment consistent with the invention, the previously described connection pads may be further enlarged to enhance wetting and solder flow during docking. The arrangement may result in a further enlargement of the front row and/or last row enlarged pad into a “T” or upside down “U” configuration.

In another embodiment consistent with the invention, the front row ground pad includes at least one through hole configured in front of the front row connection of one or more columns for providing structural rigidity to a connector array that is connected to the circuit board. As with other embodiments discussed herein, such features may reduce shear and tensile stress forces, while tolerating greater connector misalignment.

These and other advantages and features that characterize the invention are set forth in the claims annexed hereto and forming a further part hereof. However, for a better understanding of the invention, and of the advantages and objectives attained through its use, reference should be made to the Drawings, and to the accompanying descriptive matter, in which there are described exemplary embodiments of the invention.

### BRIEF DESCRIPTION OF THE DRAWINGS

FIG. 1 is a side view schematic diagram of a prior art loading arrangement on SMT solder leads of a circuit board;

FIGS. 2A and 2B are two side view schematic diagrams illustrating the prior art SMT pad arrangement for connecting the leads of each wafer and showing the first row pad configuration and a typical tolerance pad shift;

FIG. 3 is a side view schematic diagram showing the modification of one embodiment of a first row SMT pad arrangement in accordance with aspects of the invention;

FIG. 4 is a top plan view of a pad array showing two columns of pads, including front row ground pads as implemented in the prior art;

FIG. 5 is a top plan view of a pad array illustrating a modification of the front row ground pads in accordance with an embodiment of the invention;

FIG. 6 is a top plan view of a pad array showing a second embodiment of the invention;

FIG. 7 is a top plan view of a pad array showing a third embodiment of the invention;

FIG. 8 is a side view of a wafer design implemented in large scale connectors used on the boards in accordance with aspects of the invention;

FIG. 9 is a perspective view of the wafer of FIG. 8 shown in exploded form, and showing ground leads and signal leads that may be solder connected to the pad arrangement in accordance with the invention;

FIG. 10 is a partial perspective view illustrating how a large connector populated with wafers may be docked on a circuit board implementing a pad arrangement in accordance with the invention; and

FIGS. 11A and 11B are top plan views of two modifications designed to promote wetting and solder flow.

### DETAILED DESCRIPTION OF THE PREFERRED EMBODIMENTS

Embodiments consistent with the principles of the present invention provide, among other features, a pad array for a SMT board. The pad array may include a front row ground pad as a single pad, followed by a signal pad. The ground pads internal to the array may be arranged as pairs of pads interconnected to each other. They may be connected in an H-shaped configuration. The ground pads sandwich signal pads on the internal portion of the array. To minimize stress on connector wafers of large scale connectors relative to the front row ground pad, the front row ground pad is enlarged by a predetermined amount in a Y-direction to minimize potential formation of stress risers, while ensuring that electrical spacing requirements to adjacent signal leads are preserved for optimal signal integrity.

FIG. 1 is a schematic diagram of a prior art solder connection between a circuit board 11 and a large scale connector 13. One such connector is commercially available from Amphenol TCS under the trademark, “Ventura.” As may be appreciated from the figure, the connector 13 is connected to the circuit board 11. More particularly, the connection may be accomplished through solder leads 16 on the connector 13 to pads 18, of rows A through P to form connections 15. In such arrangements, a front row connection 17 may be subjected to tension and shear forces 21. These forces tend to cause cracks in the solder connections when the connector 13 is docked as shown in FIG. 1 using a separate mating face 19 of the connector 13 for a complementary mating connector, also having rows A through P.

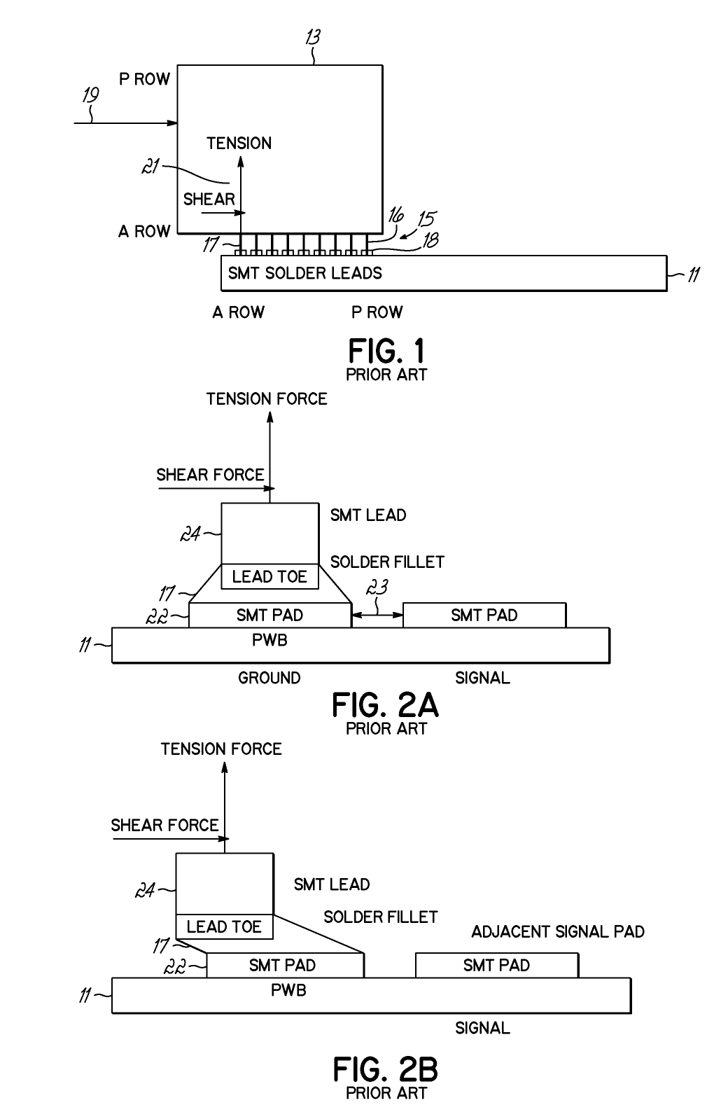

FIG. 2A is a schematic diagram illustrating the front row connection 17 of FIG. 1 in greater detail. More particularly, FIG. 2a shows a connection 17 between a ground pad 22 separated from an adjacent signal pad by a characteristic spacing 23, as is known to those of ordinary skill in the art. The ground pad 22 has connected thereto a solder joint lead 24 of a wafer housed in the connector 13.

FIG. 2B is a side view schematic diagram illustrating the prior art SMT pad arrangement, showing a typical tolerance pad shift that may occur as a result of stress forces.

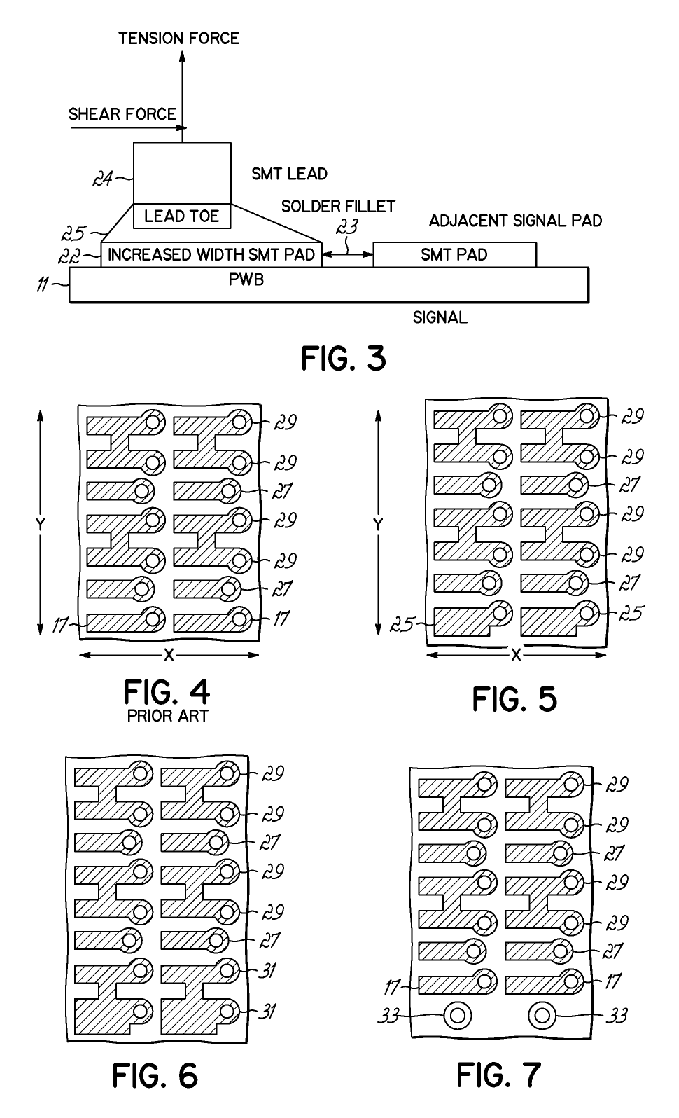

In the embodiment illustrated in FIG. 3, robustness in tolerances for connections to the front row pad 17 are increased by enlarging the front row ground pad 25 as shown therein. Such features may reduce shear and tensile stress forces, while tolerating greater connector misalignment. In other aspects, the SMT pad arrangement of the circuit board 11 may remain similar. FIG. 3 is a side view of the embodiment of FIG. 5 shown along the X-direction of FIG. 5.

More specifically, and as shown in FIG. 4, Amphenol Ventura type connectors and wafers arranged therein allow for 25 percent SMT lead misregistration in the Y-direction of the lead position relative to the SMT pad layout. The embodiment consistent with the invention and shown in FIG. 5 includes an enlarged front ground pad within a pad array on the circuit board. More particularly, the pad may be sized in the Y-direction (shown in FIG. 5) by an amount that is at least 25 percent of the lead width larger, and preferably 50 percent, with respect to comparable dimensions of the internal connector pads of the array. Full uniform lead solder fillets may be used to retard the potential formation of stress risers. The creation of the asymmetric array pattern also helps ensure that electrical spacing requirements relative to adjacent signal leads remain as designed for optimal signal integrity.

In another embodiment consistent with the invention, the last row pad may also be enlarged. For example, the last row of FIG. 1 may be enlarged such that both the front row pad and the last row pad are enlarged in the Y-direction.

FIG. 4 is a partial top down view of an array of pads illustrating a conventional arrangement. As may be appreciated from that view, a front row of ground pads 17 is shown followed by a row of signal pads 27 extending in the Y-direction shown from the front row ground pads 17. In the array, as may be appreciated, the remaining ground pads 29 may be redundant pairs interconnected so as to sandwich the signal pads 27 therebetween.

In accordance with an embodiment of the invention illustrated in FIG. 5, the front row ground pads 25 may be enlarged in the Y-direction, as previously discussed with reference to FIG. 3 (which comprises a side view taken along the X-direction). More particularly, the pads 25 may be enlarged by at least 25 percent, and preferably 50 percent, relative to pads of known configurations, which may comprise internal signal and ground pads of the respective column. As previously discussed, the last row pad may also be enlarged in a similar manner to provide further robustness in the connections.

In the embodiment of FIG. 6, a redundant row of ground pads 31 includes an “H” pattern as shown and currently employed in ground pads internal to the array. In this regard, a design for a wafer having connection leads for connecting to the ground pads on the circuit board 11 may be modified to include an additional lead. Such wafers 35 are described below in greater detail. In this case, as with the embodiment of FIGS. 3 and 5, the front row pad of the H-configuration may be larger than the adjacent pad, which may be connected further inward along the circuit board. As in the case with the embodiment of FIGS. 3 and 5, the increase is at least 25 percent over the size of the internal pads, and preferably about 50 percent. In addition, it is also possible to make the last row pad of the pair larger in a similar manner to that of the front row.

FIG. 7 illustrates an alternative embodiment in which instead of enlarging the front row ground pad 17, a pin through hole 33 is constructed in front of the front row ground pad 17 for each column, with each column corresponding to a wafer in each connector array. The pin through hole 33 allows for soldering to provide additional structural rigidity in the current connector array where pins will be established.

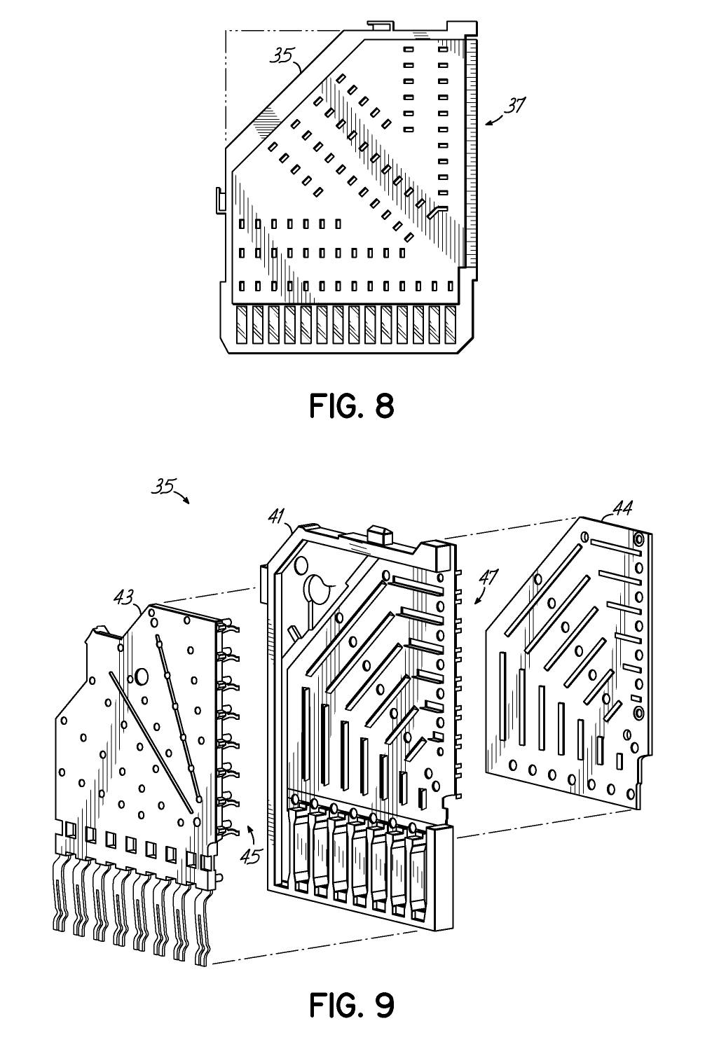

FIG. 8 illustrates a wafer design 35 in which a multitude of wafers are inserted in a connector organizer, such that surface mount connection leads 37 align with respective columns of surface mount pads on a board. In the case of the pad arrangement embodiment of FIG. 6, an additional lead may be added to the wafer 35 to ensure registration with the modified front row ground pad 31 arrangement of FIG. 6.

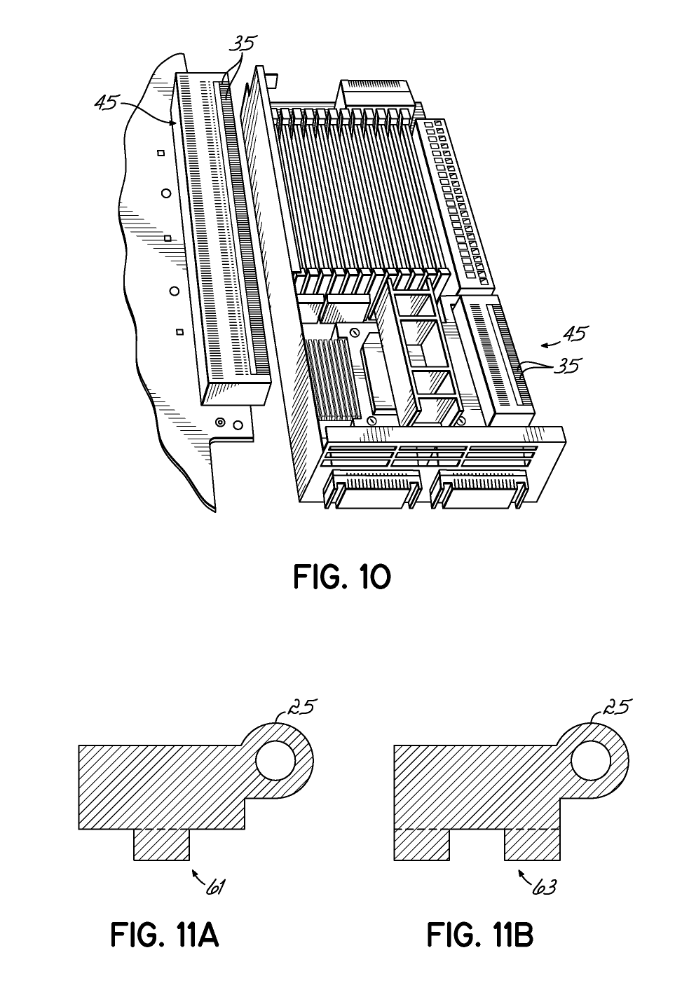

Reference is made to FIG. 9 to further understand how a large scale connector may be docked onto circuit boards with the pad arrangements described herein. FIG. 9 is an exploded view of a wafer assembly 35 that includes a signal wafer 43 in accordance with an embodiment of the invention.

It should be noted that while FIG. 8 and FIG. 9 show different numbers of leads, the invention is not so limited and may be employed with any type of selected row technology. The exemplary wafer 35 includes an insert molded signal piece 43 having signal leads 45. The signal leads 45 may eventually connect to signal pads 27 (FIGS. 5-7) of the pad array on the circuit board in accordance with aspects of the invention. The insert molded signal piece 43 may mate to an insert molded ground shield 41. The ground shield 41 may include an arrangement of ground leads 47 that mate with the pad arrangement of the circuit board. A piece 44 is constructed as a dielectic or lossy insert. The three pieces may be snapped together. Thus, once assembled, a plurality of wafers may be inserted into an organizer for being aligned with the array of pads in accordance with aspects of the invention.

The embodiment shown in FIG. 10 further clarifies how connectors may be implemented in a manner that is consistent with aspects of the invention. As shown in the figure, a plurality of wafers 35 may be mounted within a connector organizer 45, and the connector may be soldered onto a circuit board, and within a computer processor node.

In practice, wafers 35 employed in large scale connector arrays consistent with the invention are typically 8 or 14 row technology wafers. As known by those of ordinary skill in the art, there are 24 leads in the case of 8 row technology. As such, the arrangement may sequence as follows: ground, signal, ground, ground, signal, ground, ground, etc., along the surface of a wafer. In this manner, 30 wafers may be mounted in a connector organizer in the case of an 8 row form factor wafer. Of course, as may be appreciated, the invention is not limited to 8 or 14 row technology and may be implemented in a number of different arrangements.

For a wafer that uses 14 row technology, the connector/connector organizer may be relatively large, e.g., over 11 inches long, 2 inches tall and 2 inches wide. Such a connector may typically include 120 wafers and about 5,000 surface mount interconnects. As may be appreciated, the benefits provided by the enhanced docking embodiments described herein may be realized exponentially in such large scale applications. Of note, such benefits as reduced stress forces and increased alignment tolerance may be realized, in part, by designing in a manner that distinguishes conventional design trends that emphasize conserving space on circuit boards by using smaller component designs.

FIGS. 11A and 11B illustrate two different additional modifications of the front row pads, and optionally the rear row pads designed to create different wetting characteristics to force, or drive solder towards the individual lead being soldered to the individual pad. More specially, in addition to enlarging the pad in the Y-direction, the pad includes an additional extension 61 and 63 such as the “T” shape of FIG. 11A or the inverted “U” of FIG. 11B.

While the present invention has been illustrated by a description of various embodiments and while these embodiments have been described in considerable detail, it is not the intention of the Applicants to restrict, or in any way limit, the scope of the appended claims to such detail. For instance, while embodiments of the invention have been described with reference to a leading edge ground pad, it will be readily apparent to those of ordinary skill in the art that other embodiments may be alternatively implemented with other types of pad arrangements. For instance, the leading edge pad may comprise a Vdd, Vss, signal or other type of pad modified to relieve the stresses described herein.

The invention in its broader aspects is therefore not limited to the specific details, representative apparatus and method, and illustrative example shown and described. Accordingly, departures may be made from such details without departing from the spirit or scope of Applicants' general inventive concept. Having thus described the invention, the same will become better understood from the appended claims in which it is set forth in a nonlimiting manner.

1. A surface mount technology pad layout for docking large scale surface mount technology array connectors to a circuit board, comprising:
a circuit board having a pad away thereon, adjacent an edge thereof and configured for having large scale surface mount technology array connectors affixed to the pad array, said pad away comprised of a plurality of electrical connection pads arranged in rows and columns;
each column having a front row connection pad and a last row connection pad with one or more internal pads therebetween; and
said front row connection pad having a width that is sufficiently greater than the respective widths of the one or more internal pads of said pad array for minimizing stress on connector wafers of large scale connectors when docked thereon.

2. The pad layout according to claim 1, wherein said front row connection pad has a width that is at least about 25 percent larger than the respective widths of the one or more internal pads of said pad array.

3. The pad layout according to claim 1, wherein said front row connection pad has a width that is at least 50 percent larger than the respective widths of the one or more internal pads of said pad array.

4. The pad layout according to claim 1, wherein said pad away comprises a plurality of signal connection pads and ground pads, wherein each signal connection pad is sandwiched by a pair of ground pads, with each ground pad of each pair of ground pads connected to another ground pad of another pair of ground pads in a manner forming an H-shaped arrangement.

5. The pad layout according to claim 1, further comprising a large scale surface mount technology array connector having a plurality of wafers with plural surface mount leads on each wafer, and said wafers arranged therein, wherein said connector is docked on the circuit board through soldering of the leads of the wafers on corresponding ones of a plurality of electrical connection pads.

6. The pad layout according to claim 1, wherein said last row connection pad has a width greater than the respective widths of the one or more internal pads for minimizing the stress on the connector wafers of large scale connectors when docked thereon.

7. The pad layout according to claim 6, wherein said last row connection pad has a width that is at least about 25 percent larger than the respective widths of the one or more internal pads of the said pad array.

8. The pad layout according to claim 6, wherein said last row connection pad has a width that is at least 50 percent larger than the respective widths of the one or more internal pads of said pad array.

9. The pad layout according to claim 1, wherein each pad is further modified to cause solder to flow to each wafer lead when a connector is being docked on the circuit board.

10. The pad layout according to claim 9, wherein said pad further comprises a further extension in the Y-direction in the form of a T for causing said solder flow.

11. The pad layout according to claim 9, wherein said pad further comprises a further extension in the Y-direction in the form of an inverted U for causing said solder flow.

12. A surface mount technology pad layout for a circuit board comprising:
a circuit board having a pad array thereon for having an electrical connector affixed to the pad array, and said pad array comprised of a plurality of electrical connector pads arranged in rows and columns;
each said column comprising a front row pad, a last row pad and one or more internal pads; and
wherein the front row pad comprises a pad configured as a pair of electrically interconnected pads, and wherein the front pad of the pair of electrically interconnected pads further includes a width that is greater than the respective widths of the internal pads.

13. The pad layout according to claim 12, wherein said front row pad has a width that is at least 25 percent larger than the respective widths of the one or more internal pads of said pad array.

14. The pad layout according to claim 12, wherein said front row pad has a width that is at least 50 percent larger than the respective widths of the one or more internal pads of said pad array.

15. The pad layout according to claim 12, wherein said last row pad of said pad array has a width that is at least 25 percent larger than the respective widths of the one or more internal pads of said pad array.

16. The pad layout according to claim 12, wherein said last row of said pad away has a width that is at least 50 percent larger than the respective widths of the one or more internal pads of said pad array.

17. The pad layout according to claim 12, wherein each pad is further modified to cause solder flow to each wafer lead where a connector is being docked on the circuit board.

18. The pad layout according to claim 17, wherein said modification is a further enlargement of said front row pad and is in the form of a T or an inverted U.

19. A surface mount technology pad layout for a circuit board comprising:
a circuit board having a pad away thereon for having an electrical connector affixed to the pad array, and said pad away comprised of a plurality of electrical connection pads arranged in a plurality of rows and columns;
at least one of said plurality of columns having a front row connection pad; and
at least one through hole for soldering in front of the front row connection pad of the at least one column for providing structural rigidity to a connector connected to the circuit board.

20. The pad layout according to claim 19, wherein each of the plurality of electrical connection pads are modified to cause solder to flow to each wafer lead when a connector is being docked on the circuit board.
